(19) United States
(12) Patent Application Publication
(10) Pub. No.: US 2006/0069896 A1
(43) Pub. Date: Mar. 30, 2006

(54) System and method for storing data

(75) Inventor: Richard Sanders, Hutto, TX (US)

Correspondence Address: TOLER & LARSON & ABEL L.L.P., 5000 PLAZA ON THE LAKE STE 265, AUSTIN, TX, 78746, US

(73) Assignee: Sigmatel, Inc.

(21) Appl. No.: 10/952,587

(22) Filed: Sep. 27, 2004

(51) Int. Cl. G06F 12/00

(52) U.S. Cl. 711/168; 711/103

(57) ABSTRACT

The disclosure is directed to a system including a first flash memory device having a first interface and a first control interface that includes a first chip enable control input, a second flash memory device having a second interface and a second control interface that includes a second chip enable control input, and a controller that includes a data output and a control signal output. A first portion of the data output is coupled to the first interface. A second portion of the data output is coupled to the second interface. The control signal output includes a chip enable output coupled to both the first chip enable control input and the second chip enable control input. The first flash memory device and the second flash memory device are both configured to concurrently receive input data communicated to the first interface and the second interface from the data output.

### FIELD OF THE DISCLOSURE

This disclosure, in general, relates to systems and methods for storing data.

### BACKGROUND

Increasingly the consumer market is demanding portable electronic devices, such as personal digital assistants (PDA), MP3 players, portable storage systems, advanced wireless telephones, cameras, and other handheld devices. Traditional non-volatile storage mediums, such as hard drives, floppy drives and other storage devices, are generally unsuitable for portable devices. These typical devices generally have moving parts and as such are subject to mechanical failure. In addition, these devices are bulky and consume a large amount of energy. As a result, developers are turning to solid-state non-volatile memory devices, such as electrically erasable programmable read only memory (EEPROM) and flash memory, for use in portable products.

As portable computer systems become more complex, these systems tend to utilize larger memory capacities, bus speeds and word sizes. However, solid-state memory devices are generally expensive. The price of solid-state memory generally increases with increasing capacity and increasing word size. In addition, solid-state memory devices lose capacity to store data with continued usage, leading to replacement expenses.

In addition to increased costs, solid-state memory devices that utilize large word size tend to have a longer storage time per unit of storage. Slow storage times, relative to data buses used within portable devices, result in a reduction in performance and an increase in error rates. As such, an improved system and method for using solid-state storage would be desirable.

### BRIEF DESCRIPTION OF THE DRAWINGS

FIGS. 1 and 2 are block diagrams illustrating exemplary memory storage systems.

FIG. 3 is a diagram illustrating an exemplary data word.

FIGS. 4, 5 and 6 are flow diagrams illustrating exemplary methods for use in memory systems, such as those exemplified in FIGS. 1 and 2.

FIG. 7 is a diagram illustrating an exemplary data communication.

### DETAILED DESCRIPTION OF THE DRAWING(S)

In a particular embodiment, the disclosure is directed to a memory system including a microcontroller and two or more memory devices, such as non-volatile solid-state memory devices. The microcontroller includes a control interface that is coupled to each of the memory devices. The microcontroller also includes a data interface and each memory device is coupled to the microcontroller using a portion of the data interface. In addition, the microcontroller may include a data interface to an external memory bus.

Data received via the external memory bus is processed and sent to each of the memory devices. In one exemplary embodiment, data transferred to the microcontroller from the external memory bus has an associated word size. A word of data received from the external memory bus is divided and portions of the words of data are stored on each of the individual memory devices. In one particular embodiment, the data is divided such that one portion of a word is stored on a first memory device at a particular address and a second portion of the word is stored on a second memory device at the same address. To retrieve data, portions of the data word are retrieved from the particular address from each of the memory storage devices and combined to form the data word.

In one exemplary embodiment, the disclosure is directed to a system including a first flash memory device, a second flash memory device and a controller. The first flash memory device has a first interface and a first control interface. The first control interface includes a first chip enable control input. The second flash memory device has a second interface and a second control interface. The second control interface includes a second chip enable control input. The controller includes a data output and a control signal output. A first portion of the data output is coupled to the first interface of the first flash memory device. A second portion of the data output is coupled to the second interface of the second flash memory device. The control signal output includes a chip enable output coupled to both the first chip enable control input and the second chip enable control input. The first flash memory device and the second flash memory device are both configured to concurrently receive input data communicated to the first interface and the second interface from the data output.

In a further exemplary embodiment, the disclosure is directed to a method of communicating with multiple memory devices. The method includes, during a first time segment, sending command data to a first input of a first memory device while sending the command data to a second input of a second memory device. The method further includes, during a second time segment, sending address data to the first input of the first memory device while sending the address data to the second input of the second memory device and, during a third time segment, sending a first data item to be stored at an address designated by the address data to the first input of the first memory device while sending a second data item to be stored at the address designated by the address data to the second input of the second memory device.

In another exemplary embodiment, the disclosure is directed to a computer implemented method of storing a data word. The method includes receiving the data word from a data bus at a memory controller, storing a first portion of the data word at an address in a first non-volatile memory device, and storing a second portion of the data word at the address in a second non-volatile memory device concurrently with storing the first portion of the data word.

In a further exemplary embodiment, the disclosure is directed to a system including a controller, a first non-volatile memory, and a second non-volatile memory. The controller is coupled to a memory bus. The memory bus is configured to communicate data having a first word size. The first non-volatile memory device is accessible to the controller and is configured to store data having a second word size. The second non-volatile memory device is accessible to the controller and is configured to store data having a third word size. The first word size is greater than the second word size and is greater than the third word size. For a word of data having the first word size, the controller is configured to initiate simultaneous storage of a first portion of the word of data in the first non-volatile memory device and of a second portion of the word of data in the second non-volatile memory device.

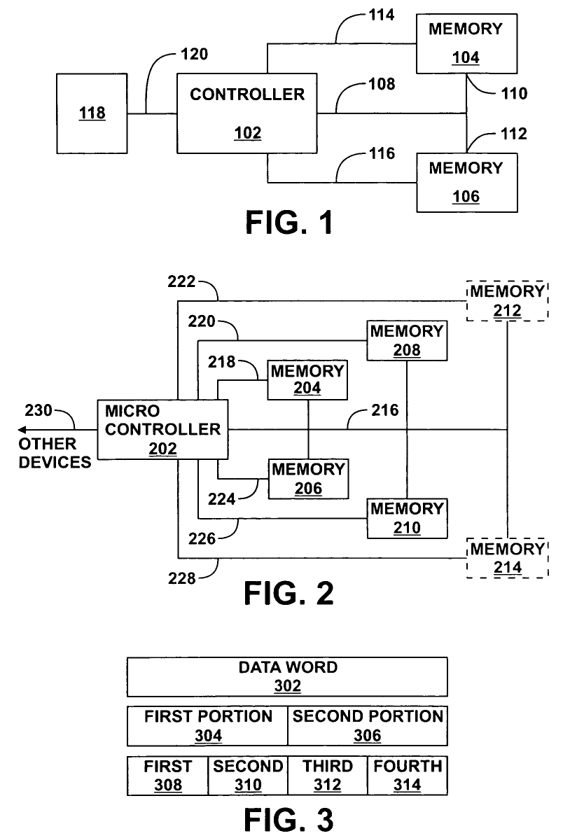

FIG. 1 is a block diagram illustrating an exemplary memory system 100 that includes a microcontroller 102 and several memory devices, 104 and 106. In one exemplary embodiment, the microcontroller 102 includes direct memory access (DMA) logic and internal random access memory (RAM). The microcontroller is coupled, by control lines 108, to the memory devices, 104 and 106, via a first control interface 110 of memory device 104 and a second control interface 112 of memory device 106. The control interfaces, 110 and 112, may include chip enable and ready/busy interfaces. In one particular embodiment, a chip enable line of the control lines 108 is coupled to both memory devices 104 and 106.

In addition, the controller 102 is coupled to memory device 104 via a first set of data lines 114 and is coupled to memory device 106 via a second set of data lines 116. In one exemplary embodiment, the microcontroller 102 includes a parallel interface and the sets of data lines, 114 and 116, are portions of a set of parallel data lines associated with the parallel interface. For example, the first set of data lines 114 may include 8 data lines that represent the first 8 bits (0-7) of a 16-bit set of parallel data lines and the second set of data lines 116 may include 8 data lines that represent the second 8 bits (8-15) of the 16-bit set of parallel data lines.

The memory devices, 104 and 106, are non-volatile storage devices, such as solid-state storage devices. For example, the memory devices, 104 and 106, may be flash memory devices or electrically erasable programmable read only memory (EEPROM). In particular embodiments, the flash memory may include NAND-type flash memory or NOR type flash memory. Each of the memory devices, 104 and 106, is configured to receive data having a particular word size via the respective sets of data lines, 114 and 116. For example, memory device 104 may be configured to receive data formatted in a predefined word size, such as 8 bits, 16 bits, 32 bits, 64 bits, or 128 bits. Similarly, memory device 106 may be configured to receive data formatted in words having 8 bits, 16 bits, 32 bits, 64 bits, or 128 bits. In one exemplary embodiment, both memory devices, 104 and 106, are configured to receive data in 8-bit word sizes. In an alternative embodiment, both memory device 104 and memory device 106 are configured to receive data formatted in words of 16 bits each.

Microcontroller 102 is also coupled to other system devices 118 via a memory bus 120. For example, the microcontroller 102 may be coupled to random access memory (RAM) storage 118 via a memory bus 120. In another exemplary embodiment, the microcontroller 102 may be coupled to external system devices 118 via a serial bus, such as a universal serial bus (USB) bus. In a particular embodiment, the data transfer rate of the memory bus 120 is greater than the data transfer rate capabilities of the first set of data lines 114 and the second set of data lines 116 or the storage rate capabilities of memory devices 104 and 106.

In one exemplary embodiment, the controller 102 receives data formatted to have data words sized in accordance with the memory bus 120. When the controller 102 writes the data, each received data word is subdivided into at least two portions. A first portion of the data word is sent to a first memory device, such as memory device 104, and a second portion of the data word is sent to a second memory device, such as memory device 106. The controller 102 may direct both memory device 104 and memory device 106 to store the received portions of the word at the same address on each respective memory device.

In one particular embodiment, controller 102 receives data for storage having a word size of 16 bits (0-15). The controller 102 enables each memory device, 104 and 106, via one chip enable line of the control lines 108 and sends the same command and address data to both the memory device 104 and the memory device 106 via respective sets of data lines, 114 and 116. For example, the controller 102 may send the same 8-bit command and 8-bit address via each set of data lines.

The controller 102 sends a first portion of the word, such as 8 bits (0-7), to memory device 104 via the set of data lines 114 and sends a second portion, such as a second 8 bits (8-15) of a 16-bit word, to the memory device 106 via the set of data lines 116. In one exemplary embodiment, the data lines are parallel lines that communicate a command, followed by an address, followed by data to be stored. In one particular embodiment, the data word portions are sent to their perspective memory devices, 104 and 106, for storage concurrently. In alternative embodiments, the memory bus word size may be 16, 32, 64, 128, or 256 bits and each word of data may be stored on two or more memory devices.

To retrieve data, the controller 102 may control the memory devices, 104 and 106, via a single chip enable line of the set of control lines 108 and send command and address data to each of the respective devices, 104 and 106, via their respective sets of data lines, 114 and 116. The controller 102 retrieves each word portion located at the particular address on each of the two different devices, 104 and 106 and, as a result, produces a full data word from the combined word portions from each of the memory devices, 104 and 106. For example, the controller 102 may read the sets of data lines, 114 and 116, as a single set of parallel data lines. The full data word may be provided via memory bus 120 to the external system devices 118.

FIG. 2 is a diagram illustrating another exemplary embodiment of a memory system. FIG. 2 includes a microcontroller 202 and memory devices 204, 206, 208, 210, and, optionally, 212 and 214. Each of the memory devices 204, 206, 208, 210, 212 and 214 are coupled to the microcontroller 202 via the same control interface 216. In addition, each of the memory devices, 204, 206, 208, 210, 212, and 214, is coupled to the microcontroller 202 via respective sets of data lines, 218, 224, 220, 226, and 222, 228. The microcontroller 202 is coupled to other devices via a memory bus 230.

In one exemplary embodiment, the memory bus 230 is configured to transmit data having a particular word size. Each of the memory devices, 204, 206, 208, 210 and, optionally, 212 and 214, has a word size that is smaller than the word size of the memory bus 230. In one exemplary embodiment, the word size of the memory bus is double the word size configured to be stored on each of the memory devices. In this example, the memory devices may be paired such that portions of words of data received via the memory bus 230 are stored within each memory device within a pair. For example, if memory bus 230 has a word size of 16 bits, then memory devices, such as memory devices 204 and 206, may have word sizes of 8 bits. Half of each word of data transferred across data bus 230 may be stored on the memory devices, 204 and 206, at the same address on each respective memory device. Similarly, words may be divided and stored on memory devices, 208 and 210, or on memory devices, 212 and 214.

In an alternate embodiment, the word size of the memory bus 230 is larger than the word size configured for storage on each of the memory devices. For example, a 32-bit word may be stored on four 8-bit memory devices, two 16-bit memory devices, or one 16-bit memory device and two 8-bit memory devices. In one particular embodiment, a 32-bit word may be divided into four 8-bit word portions and stored on four memory devices, such as memory devices 204, 206, 208 and 210. Similarly, 8-bit word portions may be retrieved from each of the memory devices, 204, 206, 208 and 210, and combined into a 32-bit word for transmission on memory data bus 230. Such a memory system may be expanded to include several sets of groupings of memory devices.

Memory devices within each group have word sizes that sum to a total word size of a memory bus attached to the microcontroller. For example, the system may include two sets of four 8-bit memory devices attached to a microcontroller for storing data transmitted across a 32-bit data memory bus. The same chip enable line may be attached to each memory device within a group and each subset (e.g. 8 data lines) of the data lines for use with a parallel data interface is attached to one of the memory devices within the group.

FIG. 3 depicts an exemplary embodiment of data words associated with a data stream. For example, a data bus may have a word size 302. The data word may be subdivided, such as in two portions, such as portion 304 and portion 306, or four portions, such as portions 308, 310, 312 and 314. For example, a 16-bit word 302 may be subdivided into two 8-bit words, 304 and 306. The first portion 302 may include the first 8-bits (0-7) of the 16-bit word and the second portion 306 may include the second 8 bits (8-15) of the 16-bit word 302. In an alternative embodiment, a 32-bit word 302 may be subdivided into two 16-bit words, such as portions 304 and 306, or further subdivided into four 8-bit words, such as portions 308, 310, 312 and 314. In alternative embodiments, a 32-bit word may be divided into two 8-bit portions and one 16-bit portion. Traditionally, data words comprise a multiple of eight bits. However, systems may be envisaged which include other variations on word size. In general, the summation of the word sizes of each of the utilized memory devices equals the word size of the memory bus.

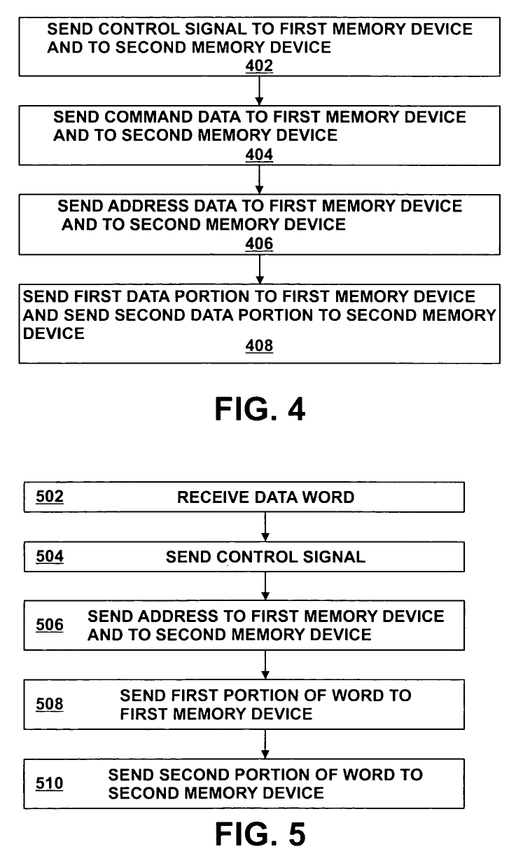

FIG. 4 is a flow diagram depicting an illustrative method for use by memory systems. To initiate storage of data, a control signal is sent to the first memory device and to the second memory device, as shown at step 402. In exemplary embodiments in which more than two devices are in use, control signals may be sent to each of the memory devices in preparation for data storage. For example, a control signal may include a chip enable signal sent via a chip enable line coupled to both the first memory device and the second memory device.

A command is sent to the first memory device and the second memory device, as shown at step 404, via their respective sets of data lines. In one exemplary embodiment, the same command is sent concurrently or substantially simultaneously to each of the memory devices via their respective sets of data lines. For example, the command may indicate that a data write operation with an address is to follow. For example, an 8-bit command may be sent in duplicate via a 16-bit parallel interface (i.e. the 8-bit command on lines 0-7 and the same 8-bit command on lines 8-15). In alternative examples, commands may be sent using subsets of lines of a parallel interface to devices configured to receive commands having a word size proportionate to the subsets of lines.

The microcontroller then sends address data indicating a particular address to the first memory device and to the second memory device via their respective sets of data lines, as shown at step 406. The address data indicates the particular address on the memory devices and may be sent concurrently or substantially simultaneously to each of the memory devices. In one particular embodiment, an 8-bit address is sent on both the first and second portions of a parallel interface. For example, the 8-bit address is sent using bits 0-7 of the parallel interface and using bits 8-15 of the parallel interface. In alternative embodiments, addresses may be sent using subsets of lines of the parallel interface to memory devices configured to receive addresses having word sizes equal to the number of lines in the subset of lines.

The microcontroller sends a first data portion to the first memory device via its respective set of data lines and sends a second data portion to the second memory device via its respective set of data lines, as shown at step 408. For example, the first data portion may be a first portion of a memory bus word and the second data portion may be the second portion of the memory bus word. In one exemplary embodiment, a 16-bit word may be received from a memory bus and sent in two 8-bit words. The microcontroller may deliver the first 8 bits (0-7) as a first data portion to the first memory device and the second 8 bits (8-15) to the second memory device for storage at the same address location. A command may be sent via the respective sets of data lines that precedes sending the portions of the data.

FIG. 5 depicts another exemplary method for use by a memory system. A data word is received via a memory bus, as shown at step 502. To facilitate storage, the microcontroller sends a control signal to each of the memory storage devices onto which the portions of the word are to be stored, as shown at step 504. The control signal is sent via a common control line, such as a chip enable line, that is connected to each of the memory devices. The microcontroller sends a particular address location to the memory devices, as shown at step 506. The address may be preceded by a command. In an exemplary embodiment, the same address is sent to all of the memory devices via their respective sets of data lines concurrently. The microcontroller sends a first portion of the word for storage to a first memory device via a subset of data lines, as shown at step 508, while also sending a second portion of the word to the second memory device via a subset of data lines, as shown at step 510. For example, a 16-bit word may be divided into two 8-bit portions. In another exemplary embodiment, a 32-bit word may be divided into two 16-bit portions or four 8-bit portions. Each portion of the data word may be preceded by a command, such as read or write command. Each portion of the data word may be sent during a common time segment. As a result, the first memory device stores the first portion of the word at the particular address and the second memory device stores the second portion of the word at the same particular address.

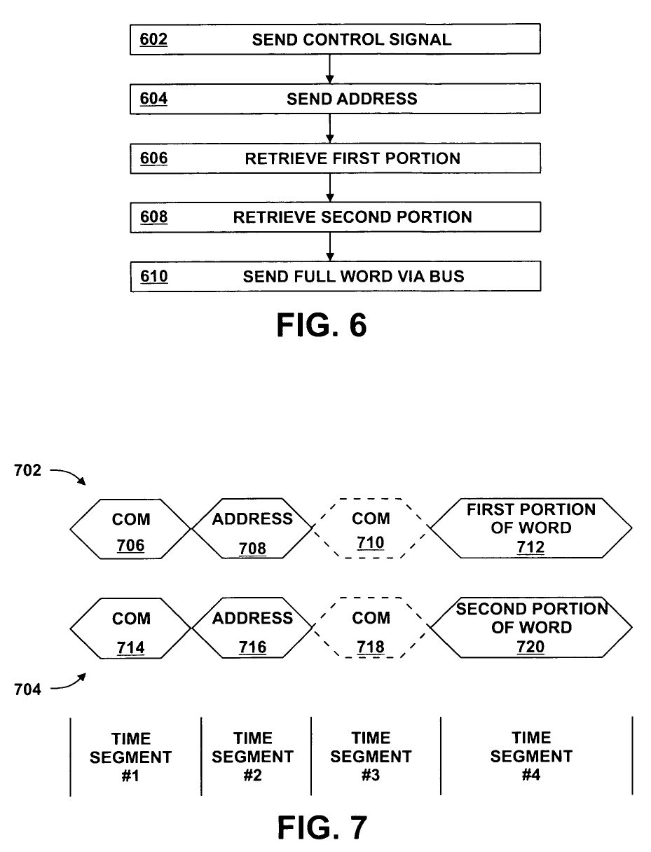

To retrieve the data stored on the memory devices, the microcontroller acquires the portions of the word, reassembles them and forwards the reassembled word to the requesting system. FIG. 6 is a flow diagram depicting an illustrative method for retrieving data from the memory devices. For example, the microcontroller may send a control signal to the memory devices via a common control line, such as a chip enable line, connected to each of the memory devices, as shown at step 602. The microcontroller sends the same particular address to each of the memory devices via their respective data lines, such as their respective subset of parallel data lines, as shown at step 604. The particular address may be sent in the same time segment, such as concurrently or substantially simultaneously, over the subsets of data lines. The address may be preceded by a memory command.

The microcontroller then retrieves portions of the data. For example, the microcontroller may retrieve a first portion of the data word from a first memory device, as shown at step 606, and may retrieve a second portion of the data word from a second memory device, as shown at step 608. If portions of the data word have been stored on more than two devices, the microcontroller may acquire the data from each of the memory devices that store a portion of the word. In a parallel environment, the portions of the word are retrieved using subsets of data lines of a parallel interface. As a result, the full data word is retrieved when each of the memory devices provides its respective portion of the full data word. The full data word, after being assembled, may be sent to requesting systems, such as RAM systems or other systems, via a memory bus, as shown at step 610.

FIG. 7 illustrates an exemplary set of data signals, such as communications signals sent to a set of memory devices via a parallel interface. For example, direct memory access (DMA) logic may initiate a write command to store data on a set of flash devices using a sequence of commands, addresses, and the data as illustrated in FIG. 7. In an exemplary embodiment, two data signals, 702 and 704, are sent to separate data interfaces on two distinct memory devices via subsets of a set of parallel interface data lines. In both data signals, 702 and 704, a common command is sent during a first time segment, as depicted at 706 and 714, and a common address is sent over both subsets of the data lines during a second time segment, as depicted at 708 and 716. For example, an 8-bit command may be sent via a first subset of 8 data lines of a 16-bit parallel interface and via a second subset of 8 data lines of the 16-bit parallel interface. Similarly, an 8-bit address may be sent via a first subset of 8 data lines of a 16-bit parallel interface and via a second subset of 8 data lines of the 16-bit parallel interface. A second command may be optionally sent over both subsets of the data lines during a third time segment, as depicted at 710 and 718.

During a fourth time segment (or a third time segment if no second command is sent), a first portion of a data word to be stored, such as bits 0-7 of a 16-bit data word, is sent as part of the first data signal 702, as depicted at 712, and a second portion of the data word, such as bits 8-15 of the 16-bit data word, is sent as part of the second data signal 704, as depicted at 720. In one particular embodiment, the first portion of the data word is sent via a first subset of the data lines of a parallel interface and the second portion of the data word is sent via the second subset of the data lines of the parallel interface. Data from multiple flash memory devices may also be retrieved using a similar sequence of command and address signals.

In alternative embodiments, the microcontroller may be coupled to memory devices via serial interfaces. Portions of a data word may be concurrently communicated to memory devices using serial communications protocols.

The above-disclosed subject matter is to be considered illustrative, and not restrictive, and the appended claims are intended to cover all such modifications, enhancements, and other embodiments, which fall within the true scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system comprising:
a first flash memory device having a first interface and a first control interface, the first control interface including a first chip enable control input;
a second flash memory device having a second interface and a second control interface, the second control interface including a second chip enable control input;
a controller including a data output and a control signal output, a first portion of the data output coupled to the first interface of the first flash memory device, a second portion of the data output coupled to the second interface of the second flash memory device, wherein the control signal output includes a chip enable output coupled to both the first chip enable control input and the second chip enable control input, and wherein the first flash memory device and the second flash memory device are both configured to concurrently receive input data communicated to the first interface and the second interface from the data output.

2. The system of claim 1, wherein the input data includes command and address data.

3. The system of claim 1, wherein the controller is a microprocessor including direct memory access logic and random access memory.

4. The system of claim 3, wherein the direct memory access logic initiates communication of a sequence of commands, addresses, and a first data portion over the first portion of the data output, and wherein the direct memory access logic issues the same sequence of commands and addresses, but with a second data portion over the second portion of the data output.

5. The system of claim 4, wherein the sequence of commands and addresses are communicated concurrently to the first interface and to the second interface.

6. The system of claim 1, further comprising a universal serial bus coupled to the controller and wherein the universal serial bus has a communication speed that is higher than the speed of the data output.

7. The system of claim 1, wherein the first flash memory device is an 8-bit NAND type flash memory and wherein the second flash memory device is an 8-bit NAND type flash memory.

8. The system of claim 1, further comprising:
a third flash memory device having a third interface and a third control interface, the third control interface including a third chip enable control input; and
a fourth flash memory device having a fourth interface and a fourth control interface, the fourth control interface including a fourth chip enable control input;
wherein the chip enable output is coupled to the third chip enable control input and to the fourth chip enable control input.

9. The system of claim 8, wherein each of the first flash memory device, the second flash memory device, the third flash memory device, and the fourth flash memory device is an 8-bit flash memory device.

10. A method of communicating with multiple memory devices, the method comprising:
during a first time segment, sending command data to a first input of a first memory device while sending the command data to a second input of a second memory device;
during a second time segment, sending address data to the first input of the first memory device while sending the address data to the second input of the second memory device; and
during a third time segment, sending a first data item to be stored at an address designated by the address data to the first input of the first memory device while sending a second data item to be stored at the address designated by the address data to the second input of the second memory device.

11. The method of claim 10, wherein the first memory device and the second memory device are non-volatile memory devices.

12. The method of claim 10, wherein the first memory device and the second memory device are solid state memory devices.

13. The method of claim 10, wherein the third time segment is subsequent to the second time segment and the second time segment is subsequent to the first time segment.

14. The method of claim 10, further comprising communicating a common control signal to a first control input of the first memory device while communicating the common control signal to a second control input of the second memory device.

15. The method of claim 10, wherein the first data item corresponds to a first segment of data originating from an external source and wherein the second data item corresponds to a second segment of data originating from the external source.

16. A computer implemented method of storing a data word, the method comprising:
receiving the data word from a data bus at a memory controller;
storing a first portion of the data word at an address in a first non-volatile memory device; and
storing a second portion of the data word at the address in a second non-volatile memory device concurrently with storing the first portion of the data word.

17. The method of claim 16, further comprising sending a control signal to the first non-volatile memory device and to the second non-volatile memory device via a control line interfaced with the first non-volatile memory device and the second non-volatile memory device.

18. The method of claim 16, wherein storing the first portion of the data word includes sending the address to the first non-volatile memory device via a first set of data lines and sending the first portion of the data word to the first non-volatile memory device via the first set of data lines.

19. The method of claim 18, wherein storing the second portion of the data word includes sending the address to the second non-volatile memory device via a second set of data lines and sending the second portion of the data word to the second non-volatile memory device via the second set of data lines.

20. The method of claim 19, wherein sending the address to the first non-volatile memory device and sending the address to the second non-volatile memory device are performed concurrently.

21. The method of claim 19, wherein sending the first portion and sending the second portion are performed during a common time segment.

22. The method of claim 19, wherein the data transfer rate of the data bus is greater than the data transfer rate of the first set of data lines and greater than the data transfer rate of the second set of data lines.

23. The method of claim 19, wherein the first set of data lines and the second set of data lines together comprise a parallel interface to the memory controller.

24. The method of claim 16, further comprising:
retrieving the first portion of the data word from the first non-volatile memory device; and
retrieving the second portion of the data word from the second non-volatile memory device concurrently with retrieving the first portion of the data word to form the data word.

25. The method of claim 16, wherein the first non-volatile memory device and the second non-volatile memory device are solid state memory devices.

26. The method of claim 16, wherein the first non-volatile memory device and the second non-volatile memory device are flash memory devices.

27. The method of claim 26, wherein the flash memory devices are NAND type flash memory devices.

28. The method of claim 16, wherein the data bus is a universal serial bus.

29. A system comprising:
a controller coupled to a memory bus, the memory bus configured to communicate data having a first word size;
a first non-volatile memory device accessible to the controller and configured to store data having a second word size;
a second non-volatile memory device accessible to the controller and configured to store data having a third word size;
wherein the first word size is greater than the second word size and greater than the third word size; and
wherein, for a word of data having the first word size, the controller is configured to initiate simultaneous storage of a first portion of the word of data in the first non-volatile memory device and of a second portion of the word of data in the second non-volatile memory device.

30. The system of claim 29, wherein the sum of the second word size and the third word size equals the first word size.
